(19) United States
(12) Patent Application Publication
(10) Pub. No.: US 2019/0209986 A1
(43) Pub. Date: Jul. 11, 2019

(54) DRUM ASSMEBLY

(71) Applicant: Taylor-Cain Corporation, Golden, CO (US)

(72) Inventor: Stephen CAIN, Castle Rock, CO (US)

(21) Appl. No.: 16/153,326

(22) Filed: Oct. 5, 2018

Related U.S. Application Data
(63) Continuation-in-part of application No. 16/053,984, filed on Aug. 3, 2018.
(60) Provisional application No. 62/540,825, filed on Aug. 3, 2017.
(60) Provisional application No. 62/568,863, filed on Oct. 6, 2017.

(51) Int. Cl. B01F 15/00; B65D 71/00; B01F 7/00; B01F 13/00

(52) U.S. Cl. CPC B01F 15/00824; B65D 71/0088; B01F 2215/0036; B01F 7/00633; B01F 13/002; B01F 7/00291

(57) ABSTRACT

A drum assembly, including a generally cylindrical barrel portion having a proximal end and a distal end and defining an interior storage volume therebetween, and a generally conical bottom member connected to the barrel portion at the distal end and a generally flat top member connected to the barrel portion at the proximal end, wherein the barrel portion and the top and bottom members enclose the interior storage volume. The bottom member defines conical shape extending towards the distal end. A top chime is operationally connected to proximal end and extending away from the distal end, and a bottom chime is operationally connected to the distal end and extending away from the proximal end. A first plurality of spaced first ribs protruding from the top chime, wherein any two respective first ribs are spaced sufficiently far apart to accept a third first rib therebetween. A second plurality of spaced second ribs protruding from the bottom chime, wherein any two respective second ribs are spaced sufficiently far apart to accept a third second rib therebetween.

### CROSS-REFERENCE TO RELATED APPLICATIONS

The present application is a nonprovisional continuation-in-part of co-pending U.S. patent application Ser. No. 16/053,984, filed on Aug. 3, 2018, which claimed priority under 35 U.S.C. § 119(e) to U.S. Provisional Patent Application Ser. No. 62/540,825, filed Aug. 3, 2017, and also claims priority to co-pending U.S. Provisional Patent Application Ser. No. 62/568,863, filed on Oct. 6, 2018, the disclosures of which are herein incorporated by reference.

### FIELD OF THE INVENTION

The field of the invention is that of storage containers. More particularly, the invention deals with drums for chemical storage, transportation and mixing.

### BACKGROUND OF THE INVENTION

A drum is a cylindrical container used for shipping bulk cargo. Drums can be made of steel, dense paperboard (commonly called a fiber drum), or plastics, and are generally used for the transportation and storage of liquids and powders. Drums are often certified for shipment of dangerous goods. Shipped goods must be matched with the make of drum necessary to comply with applicable regulations. Drums are also called barrels in common usage. Drums/barrels are commonly used in transporting and processing industrial chemicals, fuels, and oils, as well as in agricultural environments. Various other applications include special liquid material handling, fragrances, cleaning supplies, and the like.

Often in industrial settings various chemicals need to be combined in certain proportions to enable a particular result. Different mechanisms exist which allow for the combination and mixing of chemical compounds, which are often part of a large processing facility. However, there are occasions when humans must directly mix such chemicals, in which case hand held tools are a good solution.

### SUMMARY

The present invention relates to a drum barrel designed to optimize efficient storage and transportation, as well as to maximize liquid content extraction.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a first side cut-away view of a chemical drum assembly according to an embodiment of the present invention.

FIG. 2 is a side cut-away view of a second embodiment of a chemical drum assembly according to another embodiment of the present invention.

FIG. 3 is a side view of several chemical drum assemblies positioned on a pallet.

FIG. 4 is a top plan view of the several chemical drum assemblies of FIG. 3.

FIG. 5A is a prospective view of a mixer attachment according to an embodiment of the present invention.

FIG. 5B is a prospective view of a mixer attachment according to another embodiment of the present invention.

FIG. 6 is a second prospective view of the mixer attachment of FIG. 5A.

FIG. 7A is a top plan view of the mixer attachment of FIG. 5A.

FIG. 7B is a top plan view of the mixer attachment of FIG. 5B.

FIG. 8 is an exploded view of the components of a mixer attachment according to an embodiment of the present invention.

FIG. 9 is an exploded view of the bushing of FIG. 8 according to one embodiment of the present invention.

FIG. 10 is a graph of the extraction performance of an embodiment of the present invention compared to a conventional drum.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner

### DESCRIPTION OF EMBODIMENTS OF THE PRESENT INVENTION

The embodiments disclosed below is/are not intended to be exhaustive or limit the invention to the precise form disclosed in the following detailed description. Rather, the embodiment is chosen and described so that others skilled in the art may utilize its teachings.

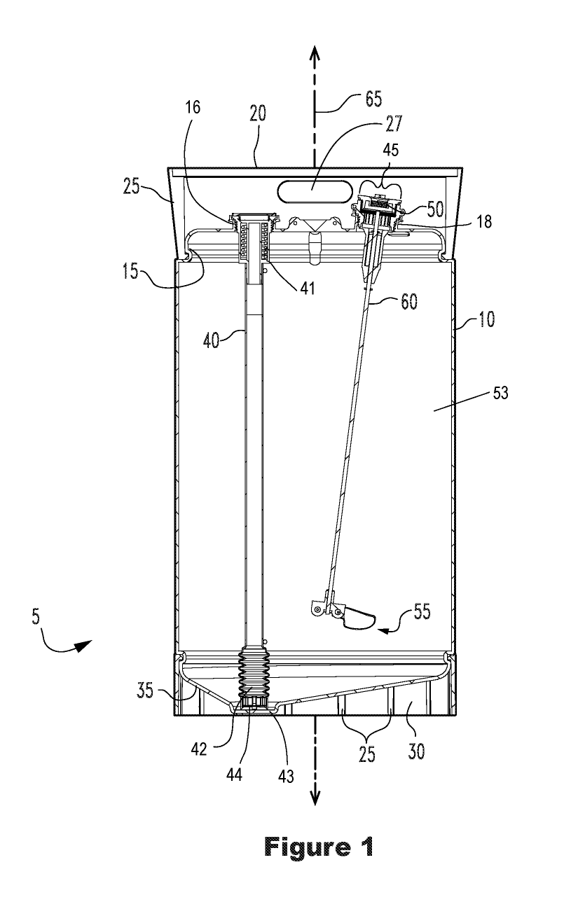

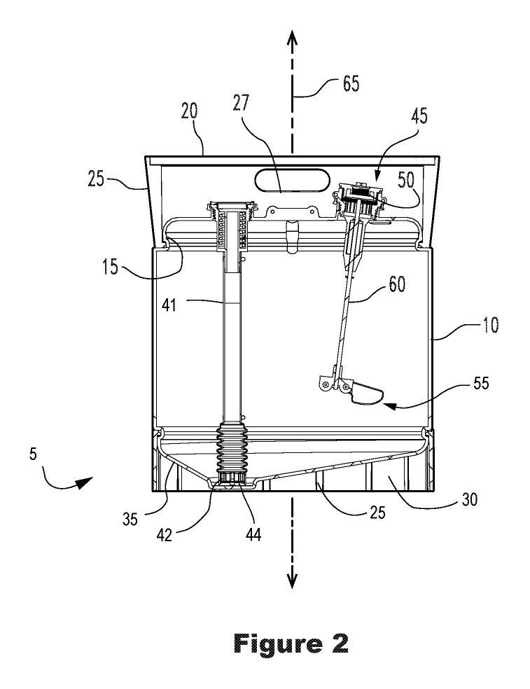

FIGS. 1 and 2 show two embodiments of drum assembly 5 according the present invention. In the exemplary embodiment of FIG. 1, drum barrel 10 has a capacity of about thirty gallons. Drum barrel 10 is generally cylindrical with a generally flat top member 15 at the proximal end with at least two access ports 16, 18, typically including pump valve port 16 and mixer head port 18. Extending in the proximal direction around and away from top portion 15 of drum barrel 10 is upper chime 20, having a plurality of support ribs 25 circumferentially and externally disposed with optional oppositely opposed hand grip holes 27. Valve 40 is inserted into drum barrel 10 through port 16, and includes proximal head 41 for (typically threadedly) engaging valve port 16, and lower valve inlet member 42 for receiving liquid content from within drum barrel 10. Lower chime 30 surrounds a typically generally conical bottom member 35 connected to drum barrel 10, and valve 40 extends from valve port 16 to lower chime 30 in conical center 43, with valve inlet member 42 typically seated in conical center 43; conical bottom portion with conical center 43 for seating the inlet member 42 provides a defined sump 44. In the exemplary embodiment, the conical center 43 is not positioned congruent with the major axis 65, so as to define a shallow angle of about 15 degrees with one portion or side of the sump 44 and a steep angle of about 35 degrees with an oppositely disposed portion or side of the sump 44. In most embodiments, valve 40 extends parallel major axis 65, such that valve port 16 is positioned directly above conical center 43 when drum 10 is oriented in an upright position. Major axis 65 extends through the drum assembly 5, parallel drum body 10 and perpendicular to generally flat top portion 15.

Mixing tool 45 includes mixer head 50 at the proximal end and extends distally into cavity 53 defined by drum barrel 10 with one or more mixing blades 55 disposed along its central shaft 60 for mixing and agitating liquids, typically chemicals, within drum barrel 10. This arrangement allows valve 40, when activated, to extract almost entirely all liquids within drum barrel 10. FIG. 2 shows a similar configuration, but one that is shorter than the exemplary embodiment of FIG. 1. For example, the exemplary embodiment drum 10 of FIG. 2 has a similar cylindrical shape and diameter, just having a shorter major axis 65, and holds approximately fifteen gallons of liquid.

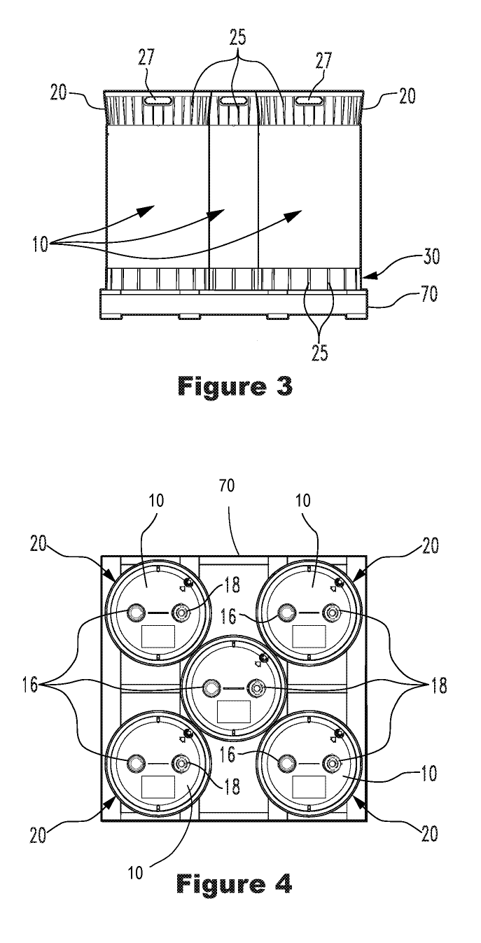

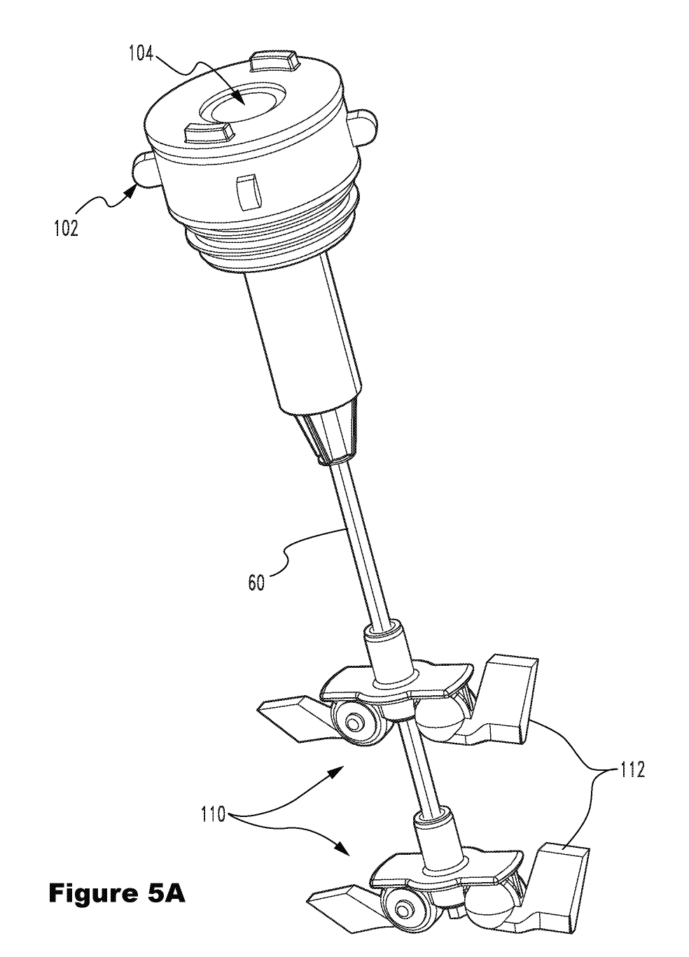

FIGS. 3 and 4 show how the embodiments of FIGS. 1 and 2 may be positioned together for storage and shipping. In FIGS. 3 and 4, respective ribs 25 of respective upper chimes 20 of adjacent barrels 10 interlock to secure the position of drum barrels 10 on a conventional pallet 70. Ribs 25 also serve the function of reinforcing and strengthening the top, or upper, chimes 20, thus increasing stability for stacking with other containers. Typically, upper chime 20 extends sufficiently far upwards so as to allow for more room to accommodate larger or taller fittings to be connected to the barrels 10. Optionally, the various drum barrels 10 may also be wrapped together by plastic bands, or other wrapping material. Valve ports 16 and mixer ports 18 are accessible from the top, allowing for drum barrels 10 to be accessed while still in the shipping configuration. Upper chimes 20 further include handles 27 to allow for manual lifting of each barrel 10. Typically, five drum barrels 10 may be conveniently placed on a single pallet 70, with one respective barrel 10 being centered on the pallet 70 and the remaining four barrels 10 each being positioned adjacent a respective corner, with ribs 25 protruding from chimes 20, 30 of central barrel 10 lockingly engaging the ribs 25 of the other four respective barrels 10. In some embodiments, pallet 70 may include preformed depressions, each respective depression sized and shaped to accept respective lower chime 30 and/or protruding ribs 25 to better secure drum barrels 10 to pallet 70.

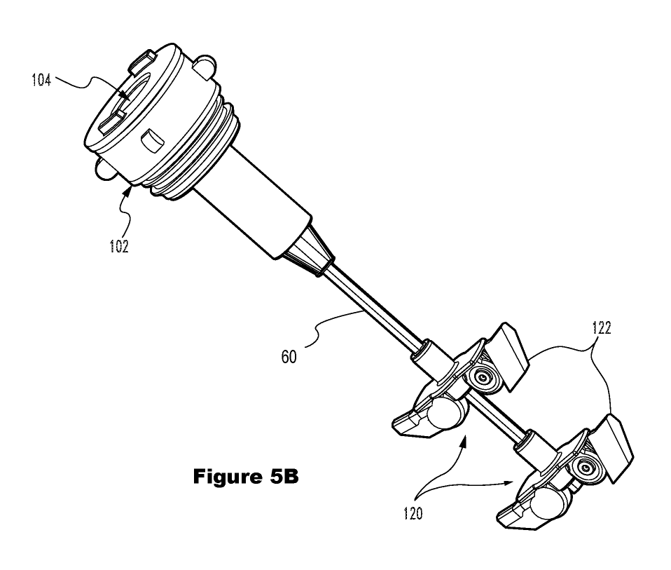

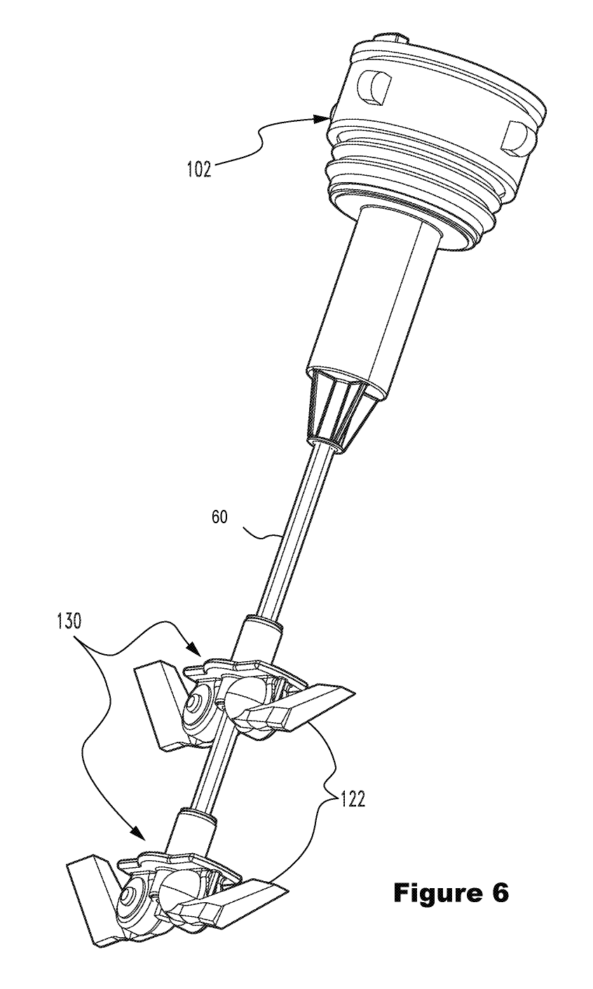

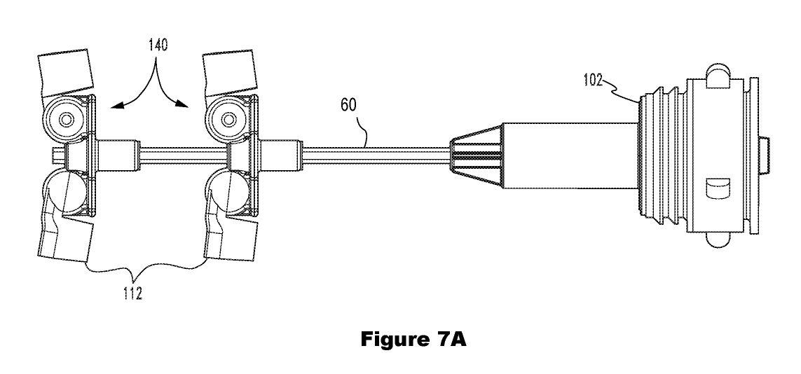

FIGS. 5-7 show one exemplary embodiment of the mixer tool, which is configured to be driven by a hand-held rotary drill tool (not shown). The mixer tool has central hexagonal shaft 60, optionally made of metal or other suitable material, for easy alignment with socket wrenches and drills, for example electric and/or pneumatic hand drills. The top of the shaft has bushing/bearing 102 setup configured for interfacing with a suitable drill tool. The housing and bushing of the top are vented at 104 to minimize bearing degradation. The lower end of shaft 60 has one or more paddle mechanisms 110, 120, 130, 140, 150 adapted to impart spinning motion along two different axes. Wing style paddles 112 (FIGS. 5A, 7A), churning style paddles 122 (FIGS. 5B, 6, 7B) are deployed on the bottom end, for agitating liquids when given motive force from the rotary shaft with centripetal force. The paddles have a rounded wing back design to reduce resistance, with the churning style paddles being more closely attached to their corresponding mechanisms. The paddles may be configured for either counter clockwise mixing blades or clockwise mixing blades. In the embodiments of FIGS. 5A, 6, and 7A the paddles are disposed upwardly. In an alternative embodiment shown in FIGS. 5B and 7B, the paddles are disposed downwardly. Other variations of paddle shape and disposition may be made according to the mixing desired.

The counter clockwise orientation of the paddles works well in smaller tanks because the paddles urge the fluid outwardly to the sides of the tank, and that urging pressure helps keep the shaft centered, not letting the shaft bend out towards the wall such that the shaft may contact the wall and damage the unit. Optionally, varying sizes of mixing blades may be deployed on the bottom of the mixer tool shaft be used for different fluids. In many embodiments, various shapes of paddles are all interchangeable on the plastic shaft hub that holds the paddle blades.

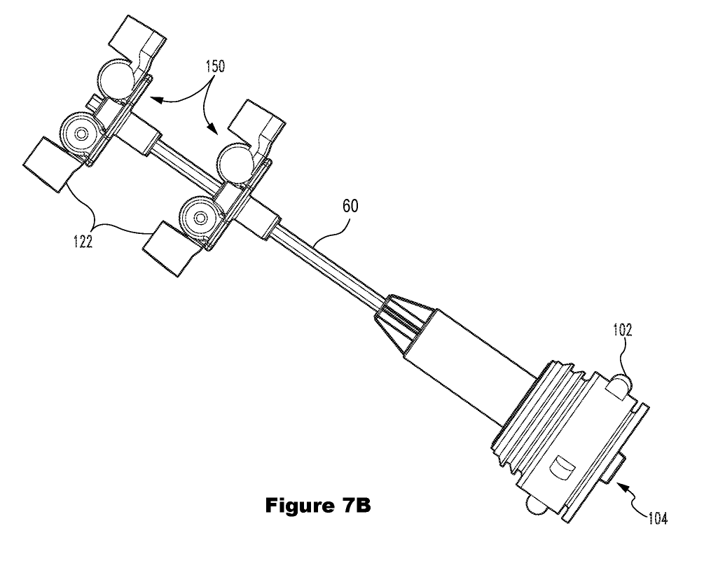

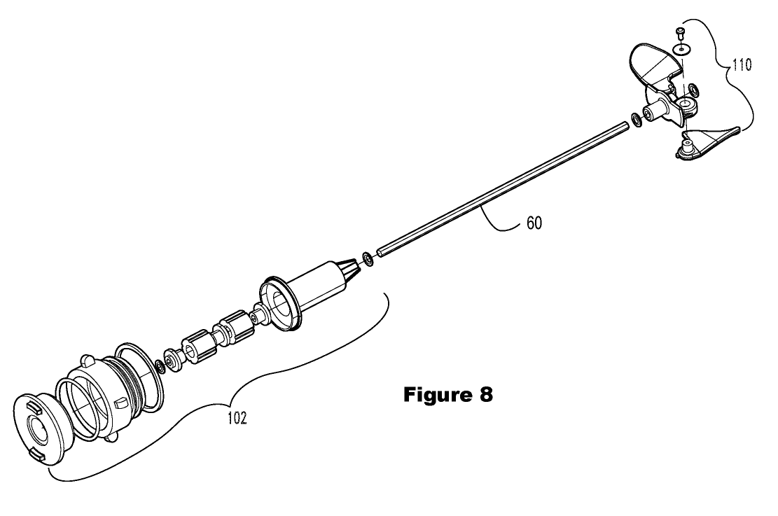

FIG. 9 shows one embodiment of the bushings of FIG. 8, with bushing 200 configured for hexagonal shaft 60 having a two-piece construction of bearings 202 fitting into each other and hub 204 which allows spin on two axis points. The exploded view of FIG. 8 shows the several component parts of one embodiment of bushing 102 and paddle mechanism 110, although various mechanical variations on the configuration of any particular paddle mechanism are possible. This disclosed arrangement reduces friction and heat that might otherwise be generated as a result of the application of a high speed of rotation of the shaft. In addition, the bodies of the bushing members are slotted, which both reduces friction and allows venting of drum 10.

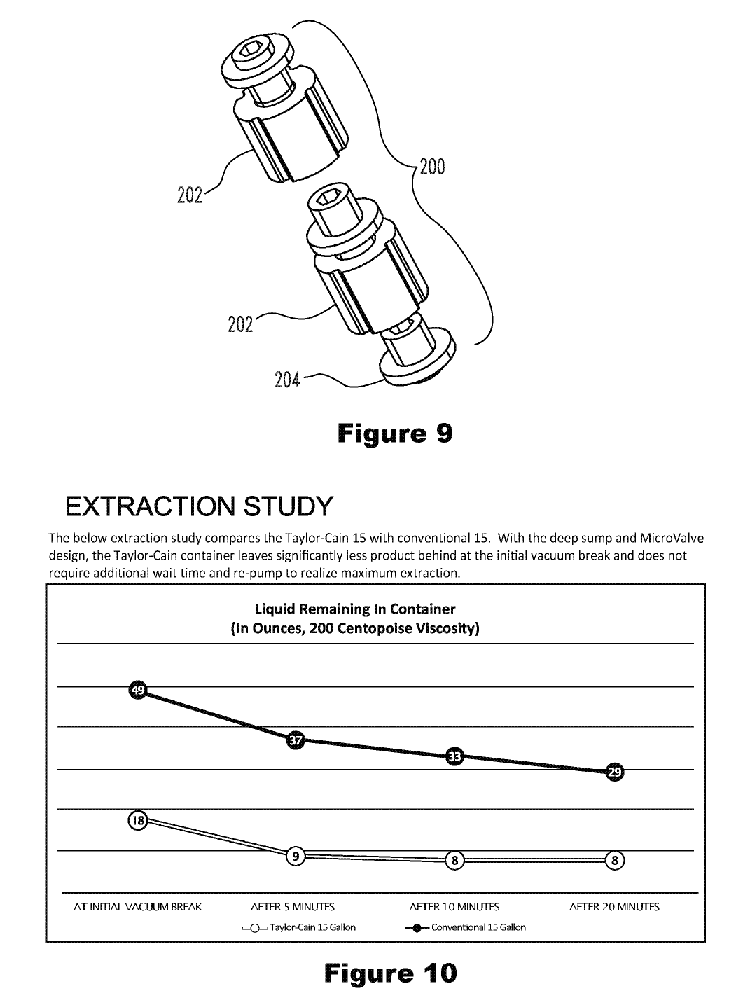

FIG. 10 compares the results of two extraction tests, one with a conventional fifteen-gallon drum and the other with a drum designed according to embodiments of the present invention. The inventive drum 10 (shown on the lower line) left significantly less product behind at the initial vacuum break and did not require additional wait time and re-pumping to realize maximum extraction. The extraction study compares the inventive embodiment drum 10 with a conventional drum. With the deep sump 44 and valve configuration, the inventive drum 10 retains significantly less product at the initial vacuum break, and after the five, ten, and twenty-minute points when measuring the liquid remaining in the container in ounces, with two hundred centipoise viscosity.

In some embodiments, bottom portion 35 is conically tapered, presenting an uneven surface for drum 10 to rest upon. Addition of bottom chime 30 provides an even, stable resting surface for drum 10. In other embodiments, bottom portion 35 has sufficient thickness to present a conical inner surface and a flat outer surface. In most embodiments, top and bottom members 15, 35 are disks and/or have generally circular cross-sectional shapes. In most embodiments, chimes 20, 30 are repeatedly removably attachable to drum assembly 5 (typically to barrel portion 10, but in some embodiments to top and/or bottom portions 15, 35), such as through threaded connection, interference fitting, snap-on connectivity, or the like. In most embodiments, ribs 25 extending from a given chime 20, 30, are spaced sufficiently far apart such that between any two consecutive ribs, a third rib (such as protruding from a separate chime 20, 30) may be accepted therebetween.

Upper chimes 20 have a sufficient height to extend above mixer head port 18 so that most conventional hand tool mixer heads (not shown) would not extend above the top wall of upper chimes 20. Mixer head port 18 is disposed at an angle relative to top portion 15, and in conjunction with bottom member 35 is configured to position mixing blades 55 in a better position for mixing the fluids in the interior of drum 10 as compared to being disposed on a rotational axis perpendicular to the plane defined by bottom chime 30. In the illustrated embodiment, mixer head port 18 is configured to support an angled position of the axis of shaft 60 so that the mixing flow currents created by mixing blades 55 sufficiently agitate substantially all of the interior volume of bottom portion 35 for better mixing. The precise angles for optimal positioning may vary according to the size of the drum, the composition of the fluids to be mixed, the length of the mixer shaft, the shape and number of mixing blades, the capacity of the mixer motor, and the particular shape of the bottom portion conical section.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A drum assembly, comprising:
a generally cylindrical barrel portion having a proximal end and a distal end and defining an interior storage volume therebetween; and
a generally conical bottom member defining a conical center and connected to the barrel portion at the distal end and a generally flat top member connected to the barrel portion at the proximal end, wherein the barrel portion and the top and bottom members enclose the interior storage volume;
a valve port operationally connected to the generally flat top member;
a generally cylindrical valve operationally connected to the valve port and extending into the pump to rest in the conical center;
wherein the bottom member defines a conical shape extending towards the distal end.

2. The drum assembly of claim 1 and further comprising:
a top chime operationally connected to proximal end and extending away from the distal end;
a bottom chime operationally connected to the distal end and extending away from the proximal end;
a first plurality of spaced first ribs protruding from the top chime, wherein any two respective first ribs are spaced sufficiently far apart to accept a third first rib therebetween; and
a second plurality of spaced second ribs protruding from the bottom chime, wherein any two respective second ribs are spaced sufficiently far apart to accept a third second rib therebetween.

3. The drum assembly of claim 2, wherein the top chime is operationally repeatedly removably connectible to the generally cylindrical barrel portion; and wherein the bottom chime is repeatedly removably connectible to the generally cylindrical barrel portion.

4. The drum assembly of claim 2, wherein the top chime is operationally repeatedly removably connectible to the generally flat top member; and wherein the bottom chime is repeatedly removably connectible to the generally conical bottom member.

5. The drum assembly of claim 1 wherein a maⱼor axis runs through the drum assembly parallel the drum body and perpendicular to the generally flat top portion; and
wherein the generally cylindrical valve extends parallel the major axis.

6. The drum assembly of claim 1 further comprising a mixer port, the mixer port configured to support a mixer shaft that extends into the interior storage volume, the mixer port being disposed at an angle relative to generally flat top member.

7. A plurality of drums, each respective drum comprising:
a generally cylindrical barrel portion having a proximal end and a distal end and defining an interior storage volume therebetween;
a bottom member connected to the barrel portion at the distal end and a top member connected to the barrel portion at the proximal end, wherein the barrel portion and the top and bottom members enclose the interior storage volume;
a top chime operationally connected to proximal end and extending away from the distal end;
a bottom chime operationally connected to the distal end and extending away from the proximal end;
a first plurality of spaced first ribs protruding from the top chime, wherein any two respective first ribs are spaced sufficiently far apart to accept a third first rib therebetween; and
a second plurality of spaced second ribs protruding from the bottom chime, wherein any two respective second ribs are spaced sufficiently far apart to accept a third second rib therebetween.
wherein the bottom member defines a conical shape extending towards the distal end;
wherein the spaced first ribs of a respective first drum interlock with the spaced first ribs of a respective adjacent second drum; and
wherein the spaced second ribs of the respective first drum interlock with the spaced second ribs of the respective adjacent second drum.

8. The drum assembly of claim 7 wherein the top chime is connected to the top member and the bottom chime is connected to the bottom member.

9. The drum assembly of claim 7 and further comprising a valve port positioned in the top member and oriented directly over the conical center.

10. A plurality of drums, each respective drum comprising:
a generally cylindrical barrel portion having a proximal end and a distal end and defining an interior storage volume therebetween;
a bottom member connected to the barrel portion at the distal end and a top member connected to the barrel portion at the proximal end, wherein the barrel portion and the top and bottom members enclose the interior storage volume;
a top chime operationally connected to proximal end and extending away from the distal end;
a bottom chime operationally connected to the distal end and extending away from the proximal end;
a first plurality of spaced first ribs protruding from, the top chime, wherein any two respective first ribs are spaced sufficiently far apart to accept a third first rib therebetween; and
a second plurality of spaced second ribs protruding from the bottom chime, wherein any two respective second ribs are spaced sufficiently far apart to accept a third second rib therebetween.
wherein the spaced first ribs of a respective first drum interlock with the spaced first ribs of a respective adjacent second drum; and
wherein the spaced second ribs of the respective first drum interlock with the spaced second ribs of the respective adjacent second drum.

11. The plurality of drums of claim 10, wherein each respective top chime is operationally repeatedly removably connectible to each respective barrel portion; and
wherein each respective bottom chime is repeatedly removably connectible to each respective barrel portion,

12. The plurality of drums of claim 10, wherein each respective top chime is operationally repeatedly removably connectible to the top member; and wherein each respective bottom chime is repeatedly removably connectible to each respective bottom member.

13. The plurality of drums of claim 10, wherein each respective bottom member defines a conical shape extending towards the distal end.

14. The plurality of drums of claim 10, wherein the plurality of drums is five respective drums; wherein a first respective drum is centrally positioned on a pallet;
wherein each of the remaining respective drums are positioned at a respective corner of the pallet; wherein the remaining respective drums are each in contact with the first respective drum; and wherein the chimes of the first respective drum interlock with the chimes of the remaining respective drums.

15. The plurality of drums of claim 10, wherein the ribs extending from the chimes of the remaining respective drums interlock with the ribs of the first respective drum.

16. A pallet unit of storage drums, comprising:
a pallet;
five drums positioned on the pallet, each respective drum further comprising:
a generally cylindrical barrel portion having a top end and an oppositely disposed bottom end;
a bottom member connected to the bottom end;
a top member connected to the top end;
a ribbed top chime operationally connected to top end and extending away from the bottom end;
a ribbed bottom chime operationally connected to the top end and extending away from the bottom end;
wherein there is sufficient space between any two adjacent ribs to lockingly accept another rib;
wherein a first respective drum is centrally positioned on the pallet;
wherein each of the remaining respective drums are positioned at a respective corner of the pallet;
wherein the remaining respective drums are each in locking contact with the first respective drum; and
wherein the chimes of the first respective drum interlock with the chimes of the remaining respective drums.

17. The pallet unit of claim 16 wherein the pallet lockingly accepts each respective drum.
